(19) United States
(12) Patent Application Publication
(10) Pub. No.: US 2021/0275887 A1
(43) Pub. Date: Sep. 9, 2021

(54) Friction Coating For A Hockey Stick

(71) Applicant: Tovi LLC, Stoneham, MA (US)

(72) Inventors: Tzvi Avnery, Stoneham, MA (US); Scott L. Heitmann, Stoneham, MA (US); Aaron Krause, Folcroft, PA (US); Alexander Titovs, Folcroft, PA (US)

(21) Appl. No.: 17/104,318

(22) Filed: Nov. 25, 2020

Related U.S. Application Data
(60) Provisional application No. 62/987,009, filed on Mar. 9, 2020.

(51) Int. Cl. A63B 59/70; B05D 5/02

(52) U.S. Cl. CPC A63B 59/70; A63B 2209/00; B05D 5/02

(57) ABSTRACT

The present invention can provide a sports paddle including a paddle member having first and second paddle surfaces. At least one paddle surface can have a series of spaced apart protrusions on at least a portion of the paddle surface. The protrusions can be about 0.014-0.016 inches in size, and can be spaced apart from each other by about 0.06-0.15 inches.

### RELATED APPLICATION

This application claims the benefit of U.S. Provisional Application No. 62/987,009, filed on Mar. 9, 2020. The entire teachings of the above application is incorporated herein by reference.

### BACKGROUND

Sports or Hockey sticks are sometimes wrapped with friction tape to provide desired friction, grip or performance. However, such an addition can add weight to the stick.

### SUMMARY

The present invention can provide a lightweight frictional surface for a sports stick or hockey stick. In some embodiments, the present invention can provide a sports paddle including a paddle member having first and second paddle surfaces. At least one paddle surface can have a series of spaced apart protrusions on at least a portion of the paddle surface. The protrusions can be about 0.014-0.016 inches in size, and can be spaced apart from each other by about 0.06-0.15 inches.

In particular embodiments, the sports paddle can be a hockey stick, and the paddle member can be a blade member, where the first and second paddle surfaces are first and second blade surfaces. The protrusions can be formed on at least one blade surface, and can be near conical in shape, with walls angled at about 60° from each other, and extending from the at least one blade surface about 0.015-0.016 inches. In some embodiments, the protrusions can be abrasive particles 40-60 mesh grit in size, that are adhered onto the at least one blade surface with an adhesive coating. The particles can be formed of at least one of silicon carbide and melamine. The adhesive can be water-based with little to no odor, and can dry in about 10 minutes without the aid of heated air.

The present invention can also provide an applicator for a sports paddle including a bottle containing a liquid adhesive within the bottle. A quantity of 40-60 mesh grit abrasive polymeric particles can be mixed with the liquid adhesive in about a 5:1 liquid adhesive to particle ratio. A cap for sealing the bottle can have an attached brush for extending into the bottle. The polymeric particles can have a density that is light enough to be evenly elevationally suspended within the liquid adhesive when shaken for even dispersion of the polymeric particles over bristles of the brush, thereby allowing even distribution of the polymeric particles with the liquid adhesive by the brush over surfaces of the sports paddle.

In particular embodiments, the polymeric particles can be formed of melamine. The adhesive can be water-based with little to no odor, and can dry in about 10 minutes without the aid of heated air.

The present invention can also provide a method of forming a sports paddle including providing a paddle member having first and second paddle surfaces. At least one paddle surface can have a series of spaced apart protrusions formed on at least a portion of the paddle surface. The protrusions can be about 0.014-0.016 inches in size, and can be spaced apart from each other by about 0.06-0.15 inches.

In particular embodiments, the sports paddle can be formed as a hockey stick, and the paddle member can be formed as a blade member, where the first and second paddle surfaces are first and second blade surfaces. The protrusions can be formed on at least one blade surface, and can be near conical in shape, with walls angled at about 60° from each other, and extending from the at least one blade surface about 0.015-0.016 inches. In some embodiments, the protrusions can be abrasive particles 40-60 mesh grit in size, that are adhered onto the at least one blade surface with an adhesive coating. The particles can be formed of at least one of silicon carbide and melamine. The adhesive can be water-based with little to no oder, and can dry in about 10 minutes without the aid of heated air.

The present invention can also provide a method of applying abrasive particles to a surface of a sports paddle including shaking an applicator comprising a bottle with a cap and attached brush containing liquid adhesive with a quantity of 40-60 mesh grit abrasive polymeric particles mixed with the liquid adhesive in about a 5:1 liquid adhesive to particle ratio. The polymeric particles can have a density that is light enough to be evenly elevationally suspended within the liquid adhesive when shaken for even dispersion of the polymeric particles over bristles of the brush. The polymeric particles can then be evenly distributed with the liquid adhesive over the surface of the sports paddle with the brush.

In various embodiments of the present invention, the polymeric particles can be formed of melamine. In addition, the adhesive can be water-based with little to no odor, and can dry in about 10 minutes without the aid of heated air.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a front view of a lower portion of an embodiment of a sports or hockey stick in the present invention.

FIG. 2 is an enlarged view of a portion of the blade of the hockey stick of FIG. 1

FIG. 3 is a side view of an embodiment of a protrusion for a sports or hockey stick.

FIG. 4 is a schematic view of an embodiment of an adhesive layer or coating having spaced apart abrasive particles bonded therein.

FIG. 5 is a schematic view of another embodiment of an adhesive layer or coating having polymeric particles bonded therein.

FIG. 6 is a side view of an embodiment of a bottle and applicator for storing and applying adhesive and particles.

FIG. 7 is a side view of FIG. 6 after shaking to suspend the particles.

FIG. 8 is a front view of a hockey stick with adhesive and particles being applied.

FIG. 9 is a front view of a lower portion of another embodiment of a sports or hockey stick in the present invention.

FIG. 10 is a front view of an embodiment of a paddle in the present invention.

### DETAILED DESCRIPTION

A description of example embodiments follows.

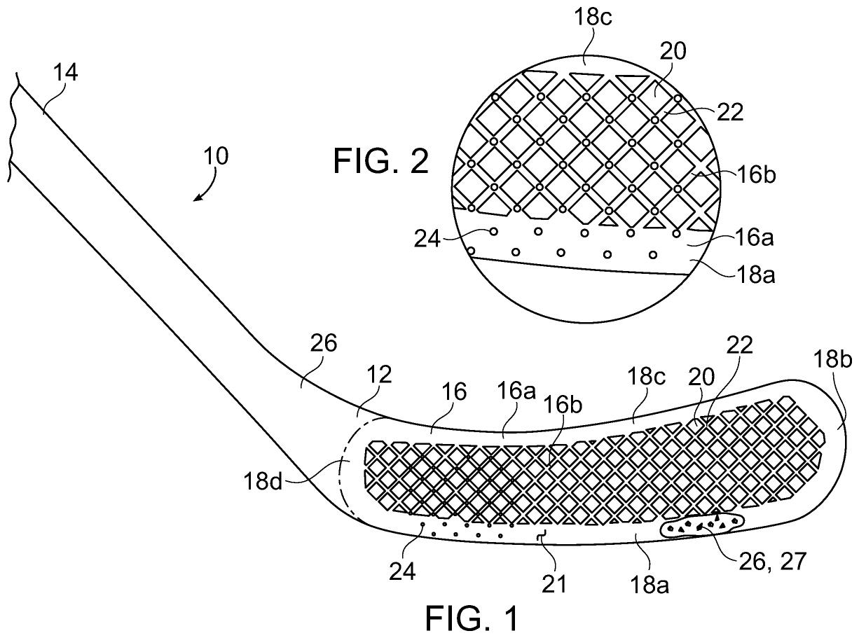

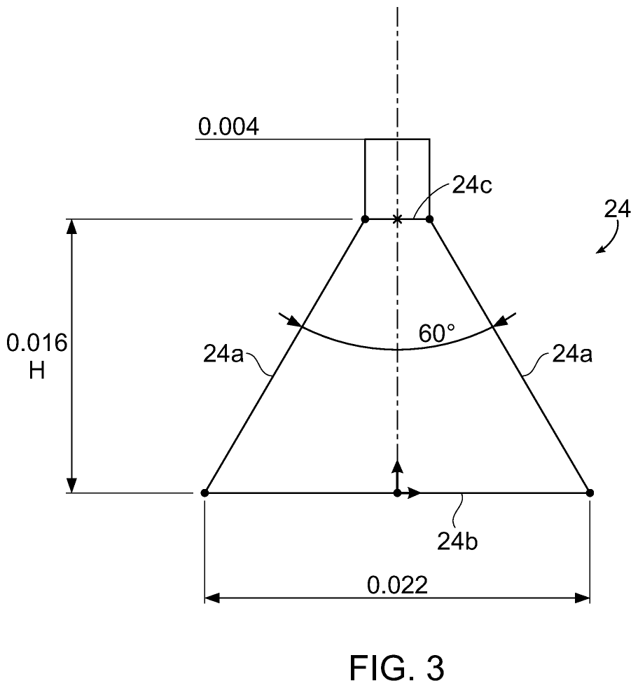

Referring to FIGS. 1-3, embodiments of the present invention can provide a sports or hockey stick 10 having a paddle or blade 12 extending from a shaft 14. The blade 12 can have a paddle or blade portion or member 16, which can be formed of carbon fiber and have an outer periphery, ring or rim 16a, and an inner or central paddle blade region or area 16b. The blade member 16 can have a lower or bottom portion, edge or side 18a, a rounded distal toe portion 18b, an upper top portion, edge or side 18c, and a proximal heel portion, end or side 18d. The blade member 16 can also have front and rear surfaces or faces 21. The central blade region 16b can have a series of apertures, holes or openings 20, and connected crisscrossing or intersecting ribs or beams 22. At least one face 21 can have a series of spaced apart protrusions 24 extending from the face 21 for providing increased friction or grip for stickhandling a hockey puck.

Each protrusion 24 can be generally cone shaped with about a 60° included angle between the sides or walls 24a. The height H of each protrusion 24 can be about 1/64 inches, such as 0.014-0.016 inches, with 0.015-0.016 inches being preferred in some embodiments. The base 24b can have a diameter or width of about 0.022 inches, and the tip 24c can have a small flat such as 0.004 inches, where the protrusion 24 can be frustoconical in shape. The protrusions 24 can be spaced apart from each other about 0.06-0.15 inches. In some embodiments, a spacing of 0.1-0.15 inches or 0.14 inches are preferred. In other embodiments, the protrusions 24 can be generally pyramid shaped, or otherwise generally tapering or pointed. In some embodiments, the spacing of the protrusions 24 can vary between different areas of the face 21, for example between the outer periphery 16a and the central blade region 16b or ribs 22.

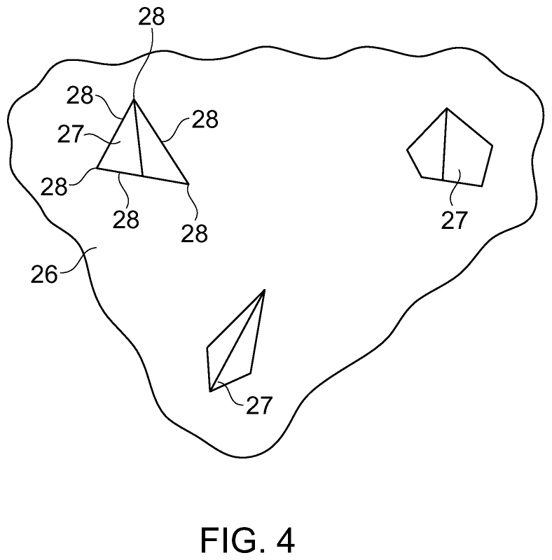

Alternatively or in addition to the protrusions 24, the at least one face 21 can include an adhesive layer or coating 26 having a series of spaced apart abrasive grit or particles 27 bonded within the adhesive coating 26 to the face 21 (FIGS. 1 and 4). The abrasive particles 27 can be jagged silicon carbide particles 40-60 mesh grit in size, about 1/64 inches or 0.014-0.016 inches in particle size, preferably 0.015-0.016 inches in some embodiments. Each particle 27 can have multiple sharp edges or points 28 so that each particle 27 can provide an aggressive grip when engaging a hockey puck during stickhandling. The spacing of the particles 27 is preferably 0.06-0.15 inches with other ranges of 0.1-0.15 inches or 0.14 inches being preferred in some embodiments. Spacing that is too close together or too far apart, can be less effective for gripping the puck. The adhesive 26 can be contact cement or can be water-based adhesive, and in some embodiments, can be hydrophobic. The adhesive 26 can be tacky when dry or cured, and can be baked on or heat cured. The cured adhesive 26 can in different embodiments be about 0.5 mils to 5 mils (0.0005-0.005 inches) thick, about 0.5 mils to 4 mils (0.0005-0.004 inches) thick, about 0.5 mils to 3 mils (0.0005-0.003 inches) thick, about 0.5 mils to 2 mils (0.0005-0.002 inches) thick, and about 1 mil (0.001 inches) thick. In some embodiments the adhesive 26 can be 40% to 55% by weight water, 40% to 55% by weight acrylic polymer, less than 1% benzenesulfonic acid, dodecyl-, branched, sodium salt, and 0.1% tol % sodium tetrapropylenebenzenesulfonate. In other embodiments, other suitable adhesives can be used. Some embodiments of adhesive 26 that are water-based, can have little to no odor, and can dry in about 10 minutes without applying heated air, such as from a hair dryer.

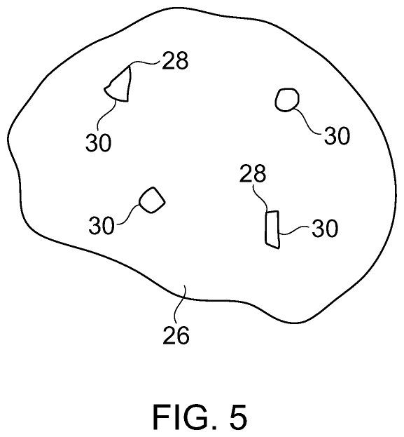

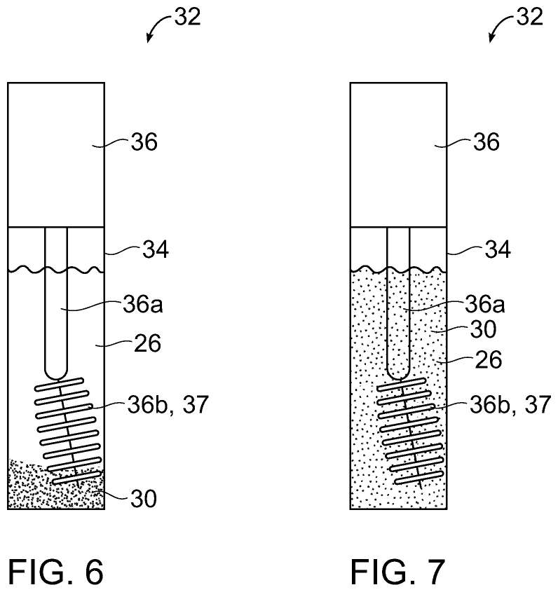

In some embodiments, in addition to or instead of the protrusions 24 and/or particles 27, or after wear from use, at least one face 21 of the blade member 16 can be coated with adhesive 26 containing jagged plastic polymeric abrasive grit or particles 30 (FIGS. 5-8) to provide friction or grip for a hockey puck. The polymeric particles 30 can have the same size and spacing as particles 27, but since formed from polymeric material, the particles 30 can have fewer sharp edges or points 28. The same adhesive 26 and adhesive thicknesses can also be used. In one embodiment, the polymeric particles 30 can be formed of melamine, such as thermoset melamine formaldehyde, a hard plastic in which jagged particles can be formed with sharp points or edges 28. The polymeric particles 30 can have a density that is low enough to be evenly suspended for a period of time within liquid adhesive 26 when shaken. In one embodiment, the density can be 1.57 g/cc. Silicon carbide has a density that is about twice that of melamine, and will not stay suspended in liquid adhesive.

In one embodiment, in order to apply the adhesive 26 and polymeric particles 30 to a face 21 of the blade member 16, the adhesive 26 and polymeric particles 30 can be stored in a narrow upright container or bottle 34 of an applicator 32. The ratio of adhesive 26 to polymeric particles 30 by weight can be about 4:1 to 6:1, or about 5:1. The applicator 32 can include a cap 36 for sealing the bottle 34, from which a central stem 36a and brush 36b can extend downwardly into the bottle 34 toward the bottom end. The brush 36b can be angled slightly relative to stem 36a, and can have generally laterally oriented bristles 37. The applicator 32 can be shaken so that the polymeric particles 30 become evenly and elevationally suspended within the vertical elevational liquid column of adhesive 26 within the bottle 34. This evenly distributes the polymeric particles 30 within the adhesive 26 and onto the bristles 37 of the brush 36b in a concentration or spacing, both laterally and elevationally, that allows the adhesive 26 and polymeric particles 30 to be applied to the face 21 of the blade member 16 with the brush 36b with the desired spacing of the particles 30, such as described above. The adhesive 26 when first applied to the face 21, can be blue or bluish in color, and then turn clear when dry or cured. This indicates that the stick 10 is ready for play. The applicator 32 can be used over the life of a hockey stick 10 to periodically add the adhesive 26/polymeric particles 30 to increase grip.

Before applying the adhesive 26 and polymeric particles 30, the face 21 of the blade member 16 of the sports or hockey stick 10 can be prepared to ensure proper adhesion and bonding. The blade member 16 is best dry and cleaned of any dust and debris. For some sports and hockey sticks, the face(s) 21 of the blade member 16 can be pre-scuffed or roughened with a scouring pad or sand paper.

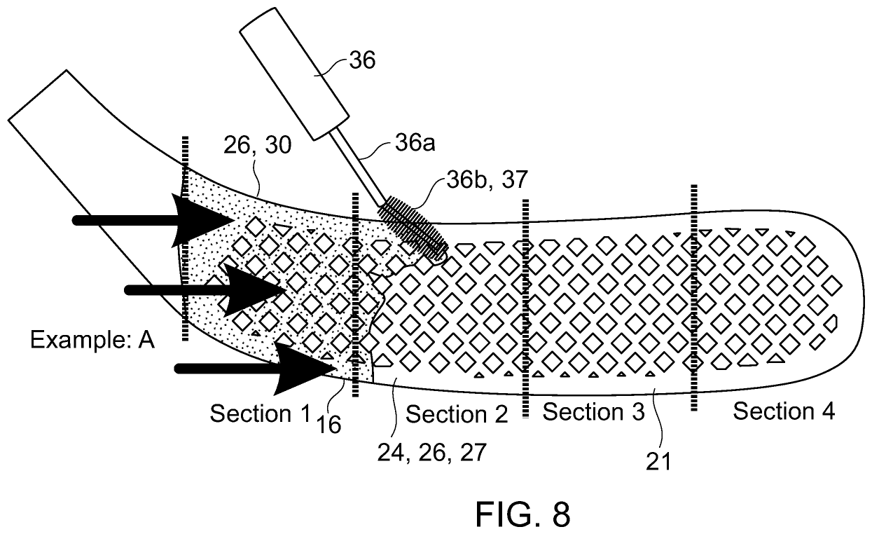

The bottle 34 with the cap 36 on, can be shaken vigorously for a sufficient time period to evenly distribute and suspend the polymeric particles 30 within the adhesive 26, such as about 20 seconds. The bottle 34 can be opened and the brush 36b removed and reinserted into the adhesive 26 and polymeric particles 30 to fully coat the brush 36b with adhesive 26 and polymeric particles 30. The brush 36b can be moved across the grain of the blade member 16, as seen in FIG. 8 Example A, to apply the adhesive 26 and polymeric particles 30. This can allow the coating to create a flat seal on the face 21 and prevent air bubbles from forming over the ribs or beams 22. About ¼ of the face 21 of the blade member 16 can be completed at a time, as sections 1-4. The brush 36b can be recoated each time between sections by inserting into the bottle 34 of adhesive 26 and polymeric particles 30. The brush 36b is preferably not pushed through holes 20 in the blade member 16. The brush 36b can be tapped against the face 21 to deposit extra amounts of polymeric particles 30 in desired areas. A bottle 34 can be sized to provide sufficient adhesive 26 and polymeric particles 30 to coat the front and rear faces 21 of the blade member 16.

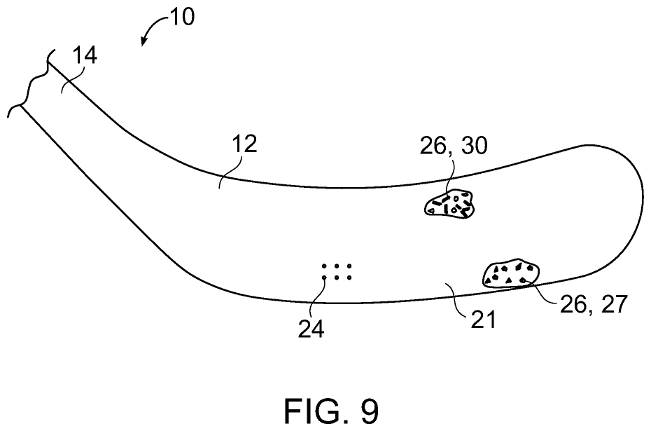

Referring to FIG. 9, in some embodiments, the protrusions 24, adhesive 26/particles 27, and/or adhesive 26/particles 30, can be applied to a hockey stick 10 that has a solid face 21. This can be a conventional hockey stick 10.

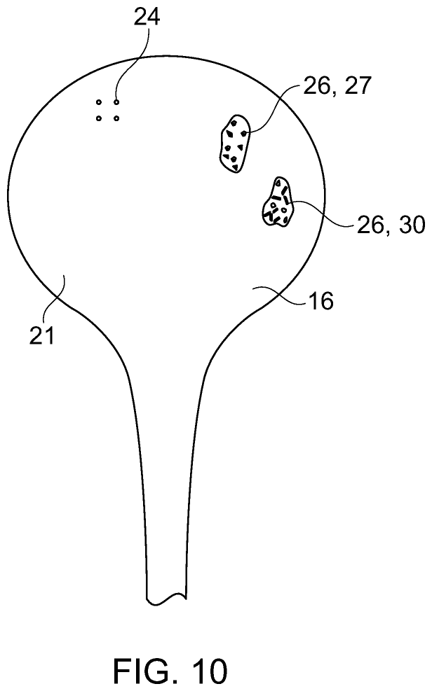

Referring to FIG. 10, in some embodiments, the protrusions 24, adhesive 26/particles 27, and/or adhesive 26/particles 30, can be applied to a paddle 16 such as for a paddle game, including lawn and beach paddle games, ping-pong, etc. The face 21 can be solid, or some embodiments can have openings 20 and ribs 22.

While example embodiments have been particularly shown and described, it will be understood by those skilled in the art that various changes in form and details may be made therein without departing from the scope of the embodiments encompassed by the appended claims. In some embodiments, non-water-based adhesives can be used, and other suitable materials can be used for the particles. In some embodiments, the bottle can contain silicon carbide particles in the adhesive.

What is claimed is:

1. A sports paddle comprising:
a paddle member having first and second paddle surfaces, at least one paddle surface having a series of spaced apart protrusions on at least a portion of the paddle surface, the protrusions being about 0.014-0.016 inches in size, and spaced apart from each other about 0.06-0.15 inches.

2. The sports paddle of claim 1 in which the sports paddle is a hockey stick and the paddle member is a blade member, where the first and second paddle surfaces are first and second blade surfaces.

3. The sports paddle of claim 2 in which the protrusions are formed on at least one blade surface and are near conical in shape with walls angled at about 60° from each other, and extending from the at least one blade surface about 0.015-0.016 inches.

4. The sports paddle of claim 2 in which the protrusions are abrasive particles 40-60 mesh grit in size, that are adhered onto the at least one blade surface with an adhesive coating.

5. The sports paddle of claim 4 in which the particles are formed of at least one of silicon carbide and melamine.

6. The sports paddle of claim 4 in which the adhesive is water-based with little to no odor, and can dry in about 10 minutes without the aid of heated air.

7. An applicator for a sports paddle comprising:
a bottle;
a liquid adhesive within the bottle;
a quantity of 40-60 mesh grit abrasive polymeric particles mixed with the liquid adhesive in about a 5:1 liquid adhesive to particle ratio; and
a cap for sealing the bottle having an attached brush for extending into the bottle, the polymeric particles having a density that is light enough to be evenly elevationally suspended within the liquid adhesive when shaken for even dispersion of the polymeric particles over bristles of the brush, thereby allowing even distribution of the polymeric particles with the liquid adhesive by the brush over surfaces of the sports paddle.

8. The applicator of claim 7 in which the polymeric particles are formed of melamine.

9. The applicator of claim 7 in which the adhesive is water-based with little to no odor, and can dry in about 10 minutes without the aid of heated air.

10. A method of forming a sports paddle comprising:
providing a paddle member having first and second paddle surfaces; and
providing at least one paddle surface with a series of spaced apart protrusions formed on at least a portion of the paddle surface, the protrusions being about 0.014-0.016 inches in size, and spaced apart from each other about 0.06-0.15 inches.

11. The method of claim 10, further comprising forming the sports paddle as a hockey stick and the paddle member as a blade member, where the first and second paddle surfaces are first and second blade surfaces.

12. The method of claim 11 further comprising forming the protrusions on at least one blade surface and being near conical in shape with walls angled at about 60° from each other, and extending from the at least one blade surface about 0.015-0.016 inches.

13. The method of claim 11 in which the protrusions are abrasive particles 40-60 mesh grit in size, that are adhered onto the at least one blade surface with an adhesive coating.

14. The method of claim 13 further comprising forming the particles of at least one of silicon carbide and melamine.

15. The method of claim 13 in which the adhesive is water-based with little to no odor, and can dry in about 10 minutes without the aid of heated air.

16. A method of applying abrasive particles to a surface of a sports paddle comprising:
shaking an applicator comprising a bottle with a cap and attached brush containing liquid adhesive and a quantity of 40-60 mesh grit abrasive polymeric particles mixed with the liquid adhesive in about a 5:1 liquid adhesive to particle ratio, whereby the polymeric particles have a density that is light enough to be evenly elevationally suspended within the liquid adhesive when shaken for even dispersion of the polymeric particles over bristles of the brush; and
evenly distributing the polymeric particles with the liquid adhesive over the surface of the sports paddle with the brush.

17. The method of claim 16 further comprising providing polymeric particles formed of melamine.

18. The method of claim 16 in which the adhesive is water-based with little to no odor, and can dry in about 10 minutes without the aid of heated air.
